(19) United States
(12) Patent Application Publication
(10) Pub. No.: US 2012/0313282 A1
(43) Pub. Date: Dec. 13, 2012

(54) HOLDING MATERIAL FOR CATALYST CONVERTER AND MANUFACTURING METHOD OF SAME

(76) Inventors: Tadashi Sakane, Tokyo (JP); Nobuya Tomosue, Tokyo (JP); Kazutoshi Isomura, Tokyo (JP); Yoshikazu Shinpo, Nisshin-shi (JP); Atsushi Inomata, Nisshin-shi (JP)

(21) Appl. No.: 13/578,084

(22) PCT Filed: Feb. 8, 2011
(86) PCT No.: PCT/JP2011/052651

§ 371 Date: Aug. 9, 2012

(30) Foreign Application Priority Data
Feb. 9, 2010 (JP) 2010-026498

(51) Int. Cl. B29C 70/00

(52) U.S. Cl. 264/86

(57) ABSTRACT

The present invention relates to a holding material for a catalyst converter, where the catalyst converter contains a catalyst carrier having a cross-section of a flattened shape, a metal casing to which the catalyst carrier is received, and the holding material attached to the catalyst carrier and interposed in a gap between the catalyst carrier and the metal casing, in which the holding material has a first part positioned in a minor axis direction of a cross-section of the catalyst carrier and having a high basis weight, a second part positioned in a major axis direction of the cross-section of the catalyst carrier and having a low basis weight, and a third part having a basis weight gradually decreased toward the second part from the first part.

### TECHNICAL FIELD

The present invention relates to: a holding material for a catalyst converter for holding, in a metal casing, a catalyst carrier used in a catalyst converter for removing particulates, carbon monoxide, hydrocarbons, nitrogen oxides and the like contained in exhaust gas discharged from an internal combustion engine such as a gasoline engine or a diesel engine; and a method for manufacturing the same.

### BACKGROUND ART

A holding material for a catalyst converter (hereinafter simply referred to as a “holding material”) can be obtained by wet molding an aqueous slurry containing inorganic fibers and an organic binder using a dewatering molding tool having a given shape, and subjecting the resulting molded article to hot press. The holding material is incorporated in a metal casing in a state that the holding material is attached to a catalyst carrier (hereinafter referred to as “canning”). The organic binder contained in the holding material burns out by heat applied after canning, and the inorganic fibers confined in a compressed state by the organic binder expands in a thickness direction, thereby sealing a gap between the catalyst carrier and the casing, and additionally holding the catalyst carrier.

On the other hand, with progress in low-floor structure of automobiles, investigations are made to decrease a space necessary for mounting a catalyst converter by changing a cross-sectional shape of a catalyst carrier incorporated under a floor of automobiles from a true circle to a flattened shape, that is, an ellipse or a track shape. However, there may be cases that a way of heat transmission in the catalyst carrier becomes heterogeneous or residual stress in the production step of a casing varies depending on part of the casing. Therefore, after canning, partial thermal expansion difference occurs in the casing, and therefore, the degree of expansion becomes heterogeneous. As a result, gap difference between the catalyst carrier and the casing becomes heterogeneous, and sealing property and holding force of the holding material are impaired in more expanded sites.

A holding material in which the part contacting an outer periphery in a minor axis direction of a cross-section of a catalyst carrier has a thickness larger than that of the part contacting an outer periphery in a major axis direction thereof is proposed for the catalyst carrier having a cross-section of a flattened shape (see Patent Document 1). However, the holding material disclosed in Patent Document 1 has nonuniform thickness. Therefore, the holding material can be adapted to the system called “clam shell” in which a catalyst carrier having a holding material attached thereto is sandwiched using a casing having a two-sectioned structure, but cannot be applied to a system called “stuffing” in which a catalyst carrier in the state of having a holding material attached thereto is inserted with pressure in an integrated casing.

It is not limited to a holding material for a catalyst carrier having a cross-section of a flattened shape, weight of a catalyst carrier acts downward in a vertical direction to a holding material by the influence of gravity, and as a result, a large deterioration of the part holding the bottom of the catalyst carrier occurs. Furthermore, the holding material receives vibration during motoring. Therefore, the part of the holding material opposite the bottom of the catalyst carrier, that is, the part holding the top of the catalyst carrier is liable to be deteriorated. However, countermeasures to those problems have not hitherto been made in holding materials including the holding material disclosed in Patent Document 1.

### CITATION LIST

### Patent Document

Patent Document 1: JP-UM-A-39719

### SUMMARY OF INVENTION

### Technical Problem

The present invention has been made in view of the above circumstances, and has an object to provide a holding material for a catalyst converter, which exhibits sealing property and holding force comparable to the conventional one to a catalyst carrier having a cross-sectional shape of a flattened shape such as an ellipse or a track shape, can be adopted to a stuffing system, and is difficult to be affected by load of the catalyst carrier or vibration during motoring.

### Solution to Problem

In order to solve the above problems, the present invention provides a holding material for a catalyst converter and a method for manufacturing the same.

(1) A holding material for a catalyst converter, in which the catalyst converter contains a catalyst carrier having a cross-section of a flattened shape, a metal casing to which the catalyst carrier is received, and the holding material attached to the catalyst carrier and interposed in a gap between the catalyst carrier and the metal casing, in which

the holding material has a first part positioned in a minor axis direction of the cross-section of the catalyst carrier and having a higher basis weight, a second part positioned in a major axis direction of the cross-section of the catalyst carrier and having a lower basis weight, and a third part having a basis weight gradually decreased toward the second part from the first part.

(2) A method for manufacturing a holding material for a catalyst converter, containing: pouring an aqueous slurry containing inorganic fibers into a dewatering molding tool sectioned into a deeper region, a shallower region, and a region having a depth gradually decreased toward the shallower region from the deeper region; dewatering molding the aqueous slurry to obtain a wet molded article; and drying the wet molded article while compressing the whole wet molded article in a thickness direction.
(3) A method for manufacturing a holding material for a catalyst converter, containing: pouring an aqueous slurry containing inorganic fibers into a dewatering molding tool sectioned into a region having a largest aperture ratio, a region having a smallest aperture ratio, and a region having an aperture ratio gradually decreased toward the region having a smallest aperture ratio from the region having a largest aperture ratio; dewatering molding the aqueous slurry to obtain a wet molded article; and drying the wet molded article while compressing the whole wet molded article in a thickness direction.
(4) A holding material for a catalyst converter, in which the catalyst converter contains a columnar catalyst carrier, a metal casing to which the catalyst carrier is received, and the holding material attached to the catalyst carrier and interposed in a gap between the catalyst carrier and the metal casing, in which

in the holding material, a middle point between a maximum load part to which a load of the catalyst carrier is most applied when the holding material is attached to the catalyst carrier and a minimum load part facing the maximum load part has a lower basis weight, and the basis weight is gradually increased toward the maximum load part and the minimum load part from the middle point.

(5) A method for manufacturing a holding material for a catalyst converter, containing: pouring an aqueous slurry containing inorganic fibers into a dewatering molding tool having a region in which a depth is gradually increased up to a first depth at one side and a region in which a depth is gradually increased up to a second depth at the other side, on the basis of a region having a shallower depth as a starting point; dewatering molding the aqueous slurry to obtain a wet molded article; and drying the wet molded article while compressing the whole wet molded article in a thickness direction.
(6) A method for manufacturing a holding material for a catalyst converter, containing: pouring an aqueous slurry containing inorganic fibers into a dewatering molding tool having a region in which an aperture ratio is gradually increased up to a first aperture ratio at one side and a region in which an aperture ratio is gradually increased up to a second aperture ratio at the other side, on the basis of a region having a smallest aperture ratio as a starting point; dewatering molding the aqueous slurry to obtain a wet molded article; and drying the wet molded article while compressing the whole wet molded article in a thickness direction.

### Advantageous Effects of Invention

The holding material of the present invention is a holding material for a catalyst carrier having a cross-sectional shape of a flattened shape such as an elliptical shape or a track shape, and, in the case of a catalyst carrier having an elliptical cross-section, the part positioned in a miner axis direction of the elliptical cross-section of the catalyst carrier and, in the case of a catalyst carrier having a track shaped cross-section, the part positioned in a direction of a flattened part of the cross-section of the catalyst carrier have a larger basis weight along its thickness direction, and the basis weight is gradually decreased. Due to such a gradated configuration of the basis weight, the amount of inorganic fibers expanded when thermally expanded is equivalent to the gradated configuration of the basis weight, and a gap between the holding material and the casing is filled over an overall periphery of the catalyst carrier, and the holding force becomes uniform. Furthermore, because the basis weight at the bottom and the top of the catalyst carrier is increased, deterioration of the holding material due to load of the catalyst carrier and vibration during motoring can be suppressed.

### BRIEF DESCRIPTION OF THE DRAWINGS

FIG. 1 is a view showing a first embodiment of the holding material for a catalyst converter of the present invention along a cross-sectional shape of a catalyst carrier.

FIG. 2 is a view showing a second embodiment of the holding material for a catalyst converter of the present invention along a cross-sectional shape of a catalyst carrier.

FIG. 3 is a view showing a third embodiment of the holding material for a catalyst converter of the present invention along a cross-sectional shape of a catalyst carrier.

FIG. 4 is a view showing a fourth embodiment of the holding material for a catalyst converter of the present invention along a cross-sectional shape of a catalyst carrier.

FIG. 5 is a view showing a fifth embodiment of the holding material for a catalyst converter of the present invention along a cross-sectional shape of a catalyst carrier.

FIG. 6 is a perspective view showing a mat-shaped holding material.

FIG. 7 is a perspective view showing a cylindrical holding material.

FIG. 8 is a view showing a sixth embodiment of the holding material for a catalyst converter of the present invention along a cross-sectional shape of a catalyst carrier.

FIG. 9 is a schematic view showing a dewatering molding tool used in a first manufacturing method of the present invention.

FIG. 10(A) is a cross-sectional view showing a wet molded article obtained by the first manufacturing method, FIG. 10(B) is a cross-sectional view showing a sheet obtained after compressing and drying, and FIG. 10(C) is a cross-sectional view showing a mat-shaped holding material obtained by cutting the sheet.

FIG. 11 is a schematic view showing a dewatering molding tool used in a second manufacturing method of the present invention.

FIG. 12(A) is a cross-sectional view showing a wet molded article obtained by the second manufacturing method, FIG. 12(B) is a cross-sectional view showing a sheet obtained after compressing and drying, and FIG. 12(C) is a cross-sectional view showing a mat-shaped holding material obtained by cutting the sheet.

FIG. 13 is a perspective view showing a dewatering molding tool used in a third manufacturing method of the present invention.

FIG. 14 is a cross-sectional view showing a wet dewatered molded article obtained by the third manufacturing method.

FIG. 15 is a perspective view showing a dewatering molding tool used in a fourth manufacturing method of the present invention.

FIG. 16 is a schematic view showing a dewatering molding tool used in a fifth manufacturing method of the present invention.

FIG. 17(A) is a cross-sectional view showing a wet molded article obtained by the fifth manufacturing method, FIG. 17(B) is a cross-sectional view showing a sheet obtained after compressing and drying, and FIG. 17(C) is a cross-sectional view showing a mat-shaped holding material obtained by cutting the sheet.

FIG. 18(A) is a schematic view showing a dewatering molding tool used in a sixth manufacturing method of the present invention, and FIG. 18(B) is a schematic view showing a region 152 of the dewatering molding tool used in the sixth manufacturing method of the present invention.

FIG. 19(A) is a cross-sectional view showing a wet molded article obtained by the sixth manufacturing method, FIG. 19(B) is a cross-sectional view showing a sheet obtained after compressing and drying, and FIG. 19(C) is a cross-sectional view showing a mat-shaped holding material obtained by cutting the sheet.

FIG. 20 is a perspective view showing a dewatering molding tool used in a seventh manufacturing method of the present invention.

FIG. 21 is a cross-sectional view showing a wet molded article obtained by the seventh manufacturing method.

FIG. 22 is a perspective view showing a dewatering molding tool used in a eighth manufacturing method of the present invention.

FIG. 23 is a perspective view showing a dewatering molding tool used in a ninth manufacturing method of the present invention.

FIG. 24 is a schematic view for explaining the ninth manufacturing method.

FIG. 25 is a schematic view showing a cylindrical wet molded article obtained by the method shown in FIG. 23.

FIG. 26 is a perspective view showing a dewatering molding tool used in a tenth manufacturing method of the present invention.

FIG. 27 is a perspective view showing a dewatering molding tool used in a eleventh manufacturing method of the present invention.

FIG. 28(A) is a cross-sectional view showing a wet molded article obtained by the eleventh manufacturing method, FIG. 28(B) is a cross-sectional view showing a sheet obtained after compressing and drying, and FIG. 28(C) is a cross-sectional view showing a mat-shaped holding material obtained by cutting the sheet.

FIG. 29 is a perspective view showing another dewatering molding tool used in the eleventh manufacturing method of the present invention.

### DESCRIPTION OF EMBODIMENTS

The present invention is described in detail below.

### First Embodiment

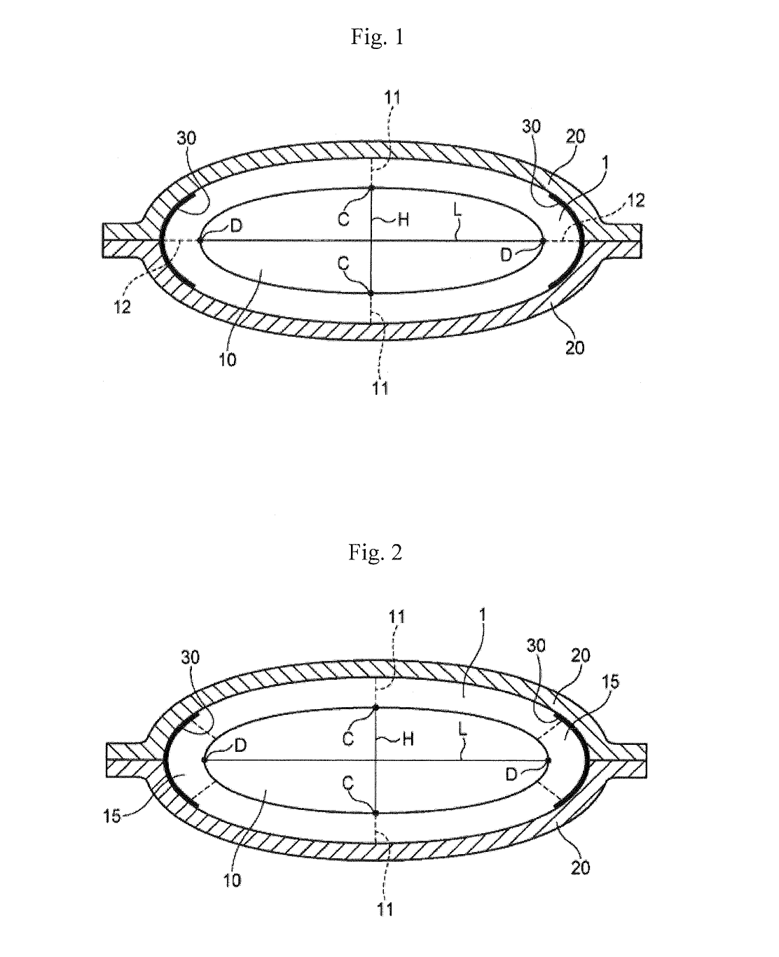

As shown in the cross-sectional view of FIG. 1, a holding material 1 is constituted such that the first part (hereinafter also referred to as the “higher basis weight part”) contacting an intersection point C of a minor axis H direction of a cross-section of a catalyst carrier 10 having a flattened cross-sectional shape (in this embodiment, the cross-section is an elliptical shape) with the outer periphery of the catalyst carrier 10 has higher basis weight along its thickness direction (a part shown by the reference numeral 11), and that the second part (hereinafter also referred to as the “lower basis weight part”) contacting both ends D of a major axis L of the cross-section of the catalyst carrier 10 has lower basis weight along its thickness direction (a part shown by the reference numeral 12). Furthermore, the third part in which a basis weigh is gradually decreased toward the lower basis weight part from the higher basis weight part is formed.

The term “basis weight” used herein means mass of fibers per unit area. In the holding material of the present invention, the range of the basis weight is not particularly limited so long as the advantage of the present invention can be exhibited, and may be from 450 to 4,500 g/m². More specifically, the range of the basis weight varies depending on a size of a space (hereinafter also referred to a “gap”) between a catalyst carrier and a casing. For example, when the gap is from 2 to 6 mm, the basis weight may be in a range of from 450 to 1,800 g/m²; when the gap is from 6 to 10 mm, the basis weight may be in a range of from 1,800 to 3,600 g/m²; and when the gap is from 8 to 12 mm, the basis weight may be in a range of from 2,250 to 4,500 g/m².

The ratio between the basis weight of the higher basis weight part and the basis weight of the lower basis weight part is not particularly limited so long as the advantage of the present invention can be achieved, and the ratio may be from 1.05 to 2.0 times, preferably from 1.1 to 1.8 times, and more preferably from 1.1 to 1.6 times. A casing 20 has a similarity shape of a catalyst carrier 10, and has an elliptical cross-section. Variability of the gap difference between the casing 20 and the catalyst carrier 10 is influenced by dimensional accuracy of the casing 20, residual stress, heating temperature and the like, but is generally 1.5 times or less. For this reason, even though such a gap difference is present, the holding material can uniformly seal over the entire periphery of the catalyst carrier 10 by adjusting the basis weight ratio to the above range.

Considering holding force, heat insulation property, sealing performance and the like, the holding material 1 preferably has a uniform thickness. Specifically, the thickness may be from 5 to 30 mm, and preferably from 6 to 12 mm. Variation of the thickness is preferably ±15% or less, more preferably ±10% or less, and further preferably ±5% or less.

The casing 20 is divided into two parts up and down in the embodiment shown in the figure. However, the holding material 1 can be canned by a stuffing system using an integrated casing. It can be expected that productivity of canning can be improved by making the thickness of the holding material 1 uniform.

When the holding material 1 is interposed in a gap between the catalyst carrier 10 and the casing 20, an average density thereof is preferably from 0.15 to 0.7 g/cm³, more preferably from 0.2 to 0.6 g/cm³, and particularly preferably from 0.25 to 0.5 g/cm³. The holding material 1 can well hold the catalyst carrier 10 by adjusting the average density to the above range.

A low friction sheet 30 having a friction coefficient of from 0.1 to 0.3 may be laminated on an outer periphery near the lowest basis weight part of the holding material 1. According to this constitution, since frictional resistance of both ends shown in the figure of the catalyst carrier 10 is decreased, when inserting with pressure into an integrated casing, the catalyst carrier 10 can smoothly be inserted into the casing. Furthermore, there can be avoided a problem that cracks and wrinkles are generated on an outer surface of the holding material 1 with the lower basis weight part pulled toward outside (casing side), in which the problem results from a decrease of curvature radius of the vicinity of the lower basis weight part when the holding material 1 is attached to the catalyst carrier 10. The cracks and wrinkles on an outer surface of the holding material 1 disturb canning, and are therefore not preferred. The low friction sheet 30 may be laminated on the entire outer surface of the holding material 1.

### Second Embodiment

In the first embodiment, the lower basis weight part of the holding material 1 is only a point shown by the reference numeral 12. However, the lower basis weight part may have a given width as shown in the reference numeral 15 in FIG. 2. Further, independent form the lower basis weight part, the higher basis weight part of the holding material 1 may also have a given width. The basis weight ratio between the higher basis weight part and the lower basis weight part is the same as in the first embodiment, and the same low friction sheet may be laminated.

### Third Embodiment

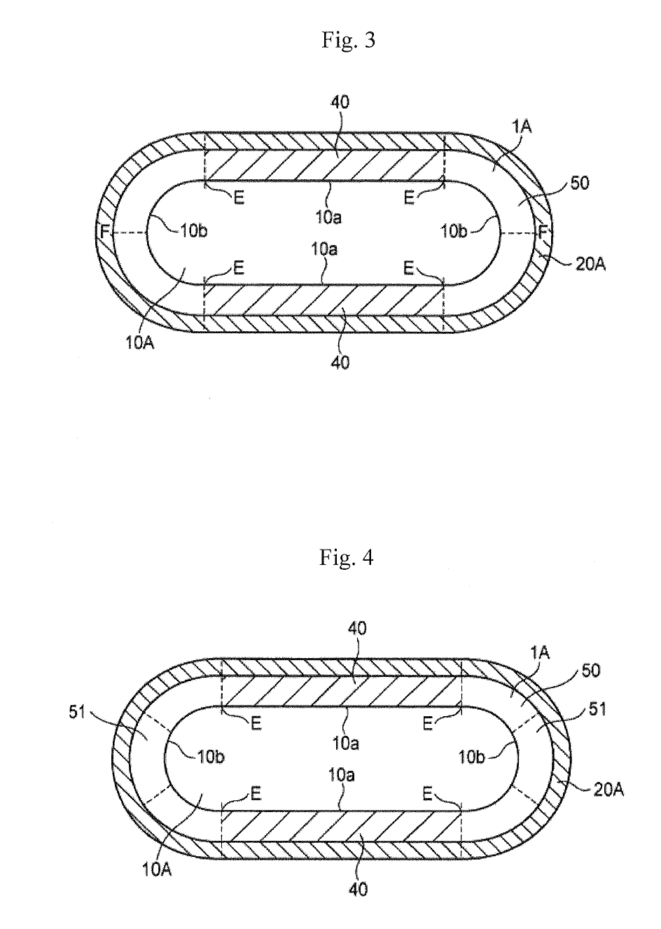

As shown in the cross-sectional view of FIG. 3, the holding material 1A of this embodiment is constituted such that a flat part 40 (higher basis weight part) contacting a flat portion 10a positioned in a minor axis direction of a cross-section (in this embodiment, the cross-section is a track shape) of a catalyst carrier 10A has a higher basis weight along its thickness part, that in a curved part 50 contacting a curved part 10b of the catalyst carrier 10A the basis weight is gradually decreased with separating from an end portion E of the flat part 40, and that a middle point F (lower basis weight part) of the curved part 50 has a lower basis weight.

The thickness of the holding material 1A is preferably uniform, the basis weight ratio between the higher basis weight part and the lower basis weight part is the same as in the first embodiment, and the same low friction sheet may be laminated on the outer periphery of the part contacting the curved part 50.

The catalyst carrier 10A is inserted in a casing 20A having a similarity shape to the catalyst carrier 10A in a state on which the holding material 1A is wound. The casing 20A is an integrated casing.

### Fourth Embodiment

In the third embodiment, the lower basis weight part of the holding material 1A is only a point shown by the reference numeral F. However, the lower basis weight part may have a given width as shown by the reference numeral 51 in FIG. 4. The basis weight ratio between the higher basis weight part and the lower basis weight part is the same as in the first embodiment, and the same low friction sheet may be laminated.

### Fifth Embodiment

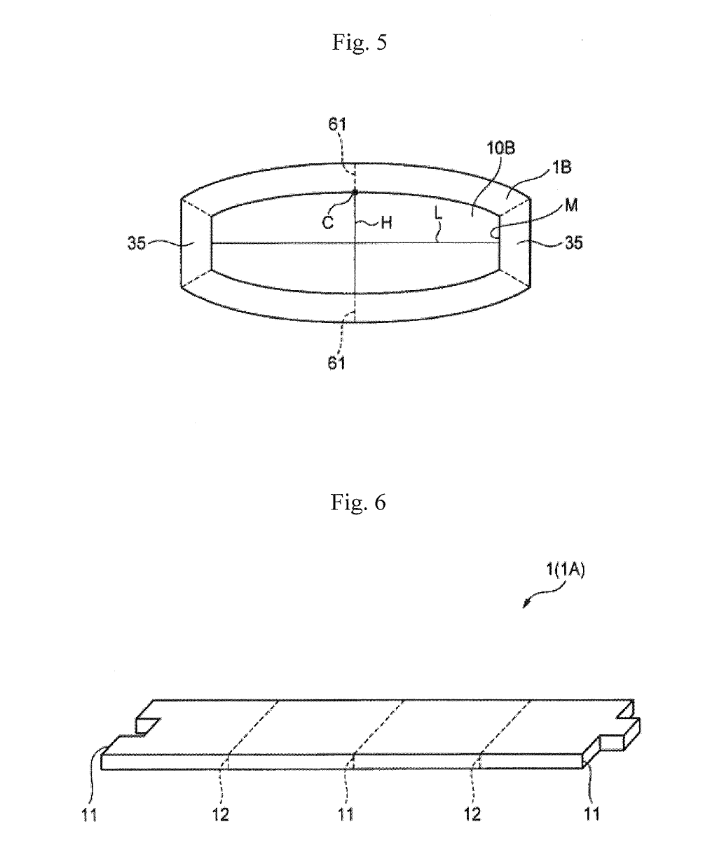

The catalyst carrier is not limited to have a cross-section of an ellipse or track shape, and may be, for example, a catalyst carrier 10B having a cross-sectional shape obtained by cutting (cutting plane M) such that both ends at the major axis side of an ellipse intersect with the major axis L as shown in FIG. 5. A holding material 1B is that a thickness part (part shown by the reference numeral 61) of a point C contacting a minor axis H of the catalyst carrier 10B constitutes the higher basis weight part and a part 35 contacting the cutting plane M constitutes the lower basis weight part. The basis weight ratio between the higher basis weight part and the lower basis weight part is the same as in the first embodiment, and the lower basis weight part may have a given width. Furthermore, the same low friction sheet may be laminated.

In addition, the catalyst carrier having a cross-section of a flattened shape may have a flattened cross-sectional view in which a circle is flattened out from intersected two diameter sides, or a cross-sectional shape having different elliptical curvature in each site, although not shown.

In each of the above embodiments, the constituent materials of the holding materials 1, 1A and 1B are not limited so long as the constituent materials contain inorganic fibers and an organic binder. If required and necessary, the constituent materials may further contain fillers, an inorganic binder and the like which are conventionally used. Although those kinds are not limited, the preferred examples thereof are shown below.

As the inorganic fibers, use can be made of various inorganic fibers conventionally used in a holding material. For example, alumina fibers, mullite fibers, or other ceramic fibers can appropriately be used. More specifically, the alumina fibers, for example, preferably have Al₂O₃ content of 90% by weight or more (the remaining is SiO₂ component) and low crystallinity based on an X-ray crystallography. The crystallinity may be 30% or less, preferably 15% or less, and more preferably 10% or less. The alumina fibers further preferably have an average fiber diameter of from 3 to 8 μm and a wet volume of 400 cc/5 g or more. The mullite fibers, for example, preferably have a mullite composition having Al₂O₃ component/SiO₂ component weight ratio of from about 70/30 to 80/20, and low crystallinity based on an X-ray crystallography. The crystallinity may be 30% or less, preferably 15% or less, and more preferably 10% or less. The mullite fibers further preferably have an average fiber diameter of from 3 to 8 μm and a wet volume of 400 cc/5 g or more. The other ceramic fibers include silica alumina fibers and silica fibers, and each of them which are conventionally used in a holding material can be used. Further, glass fibers, rock wool or bio-soluble fibers may be blended.

The wet volume is calculated by the following method: 1) A dry fiber material is weighed to be 5 g by a balance having a precision of two places or more of decimals; 2) In 500 ml glass beaker is placed the weighed fiber material; 3) In the glass beaker of 2) above is placed about 400 cc of distilled water with a temperature of from 20 to 25° C., followed by stirring with a stirrer in a careful manner such that the fiber material does not cut, thereby dispersing the fiber material. The dispersion may be conducted using an ultrasonic washing machine; 4) To a 1,000 ml measuring cylinder is transferred the contents in the glass beaker of 3) above and added distilled water up to 1,000 cc in the scale; 5) The opening of the measuring cylinder of 4) above is clogged with hand or the like, and the measuring cylinder is turned upside down to stir while watching out that water does not leak. This operation is repeated 10 times. 6) After stopping the stirring, the measuring cylinder is allowed to stand at room temperature, and a volume of fibers precipitated after 30 minutes is visually measured. 7) The above operation is conducted using three samples, and its average value is taken as a measurement value.

The organic binder may be the conventional organic binders, and use can be made of rubbers, water-soluble organic polymer compounds, thermoplastic resins, thermosetting resins, and the like. Specifically, examples of the rubbers include a copolymer of n-butyl acrylate and acrylonitrile, a copolymer of ethyl acrylate and acrylonitrile, a copolymer of butadiene and acrylonitrile, and butadiene rubber. Examples of the water-soluble organic polymer compounds include carboxymethyl cellulose and polyvinyl alcohol. Examples of the thermoplastic resins include a homopolymer and a copolymer of acrylic acid, acrylic acid ester, acrylamide, acrylonitrile, methacrylic acid and methacrylic acid ester; an acrylonitrile-styrene copolymer and an acrylonitrile-butadiene-styrene copolymer. Examples of the thermosetting resins include bisphenol type epoxy resin and novolak type epoxy resin. Those organic binders can be used in combination of two kinds or more thereof. The amount of the organic binder used is not limited so long as it is an amount capable of binding the inorganic fibers, and may be from 0.1 to 10 parts by mass per 100 parts by mass of the inorganic fibers. Where the amount of the organic binder is less than 0.1 parts by mass, there is a concern that binding force is insufficient, and where the amount exceeds 10 parts by mass, there is a concern that the amount of the inorganic fibers is relatively decreased and holding performance and sealing performance required as a holding material are not obtained. Furthermore, when the amount of an organic component in the holding material is too large, there is also a concern that the organic component in the holding material volatilizes in initial use of an automobile and an amount of hydrocarbon component contained in the gas emitted exceeds the guideline value. The amount of the organic binder used is preferably from 0.2 to 6 parts by mass, and more preferably from 0.2 to 4 parts by mass.

A small amount of organic fibers such as pulp can be blended as the organic binder. Since binding force is increased as the organic fiber is finer and longer, highly fibrilized cellulose, cellulose nanofiber and the like are preferably used. Specifically, the organic fiber has preferably a fiber diameter of from 0.01 to 50 μm and a fiber length of from 1 to 5,000 μm, and more preferably a fiber diameter of from 0.02 to 1 μm and a fiber length of from 10 to 1,000 μm.

The amount of the fibrilized fibers used is not limited so long as it is an amount capable of binding the inorganic fibers, and is from 0.1 to 5 parts by mass per 100 parts by mass of the inorganic fibers. Where the amount of the fibrilized fibers used is less than 0.1 parts by mass, there is a concern that binding force is insufficient, and where the amount exceeds 5 parts by mass, there is a concern that the amount of the inorganic fibers are relatively decreased, and holding performance and sealing performance required as a holding material are not obtained. The amount of the fibrilized fibers used is preferably from 0.1 to 2.5 parts by mass, and more preferably from 0.1 to 1 part by mass.

The fibrilized fibers may be used together with an inorganic binder. The combined use of the fibrilized fibers and the inorganic binder can well bind the inorganic fibers even in the case that the amount of the fibrilized fibers used is decreased in order to avoid the above-described disadvantages due to volatilization of the organic component at the time of use, and therefore can provide a holding material for a catalyst converter that can maintain the thickness equivalent to the conventional one. As the inorganic binder, use can be made of the conventional ones, and examples thereof include glass frit, colloidal silica, alumina sol, sodium silicate, titania sol, lithium silicate and liquid glass. Those inorganic binders can be used in combination of two kinds or more thereof. The amount of the inorganic binder used is not limited so long as it is an amount capable of binding the inorganic fibers, and is from 0.1 to 10 parts by mass per 100 parts by mass of the inorganic fibers. Where the amount of the inorganic binder used is less than 0.1 parts by mass, there is a concern that binding force is not sufficient, and where the amount exceeds 10 parts by mass, there is a concern that the amount of the inorganic fibers is relatively decreased, and holding performance and sealing performance required as a holding material are not obtained. The amount of the inorganic binder used is preferably from 0.2 to 6 parts by mass, and more preferably from 0.2 to 4 parts by mass.

The amount of the organic components contained in the holding material is preferably from 0.3 to 4.0 mass %, more preferably from 0.5 to 3.0 mass %, and particularly preferably from 1.0 to 2.5 mass %, based on the total amount of the holding material. The amount of a volatile gas generated when heat is applied after canning is reduced with decreasing the amount of the organic components in the holding material, which is preferred. The organic components can be defined by ignition loss after heating at 700° C. for 30 minutes.

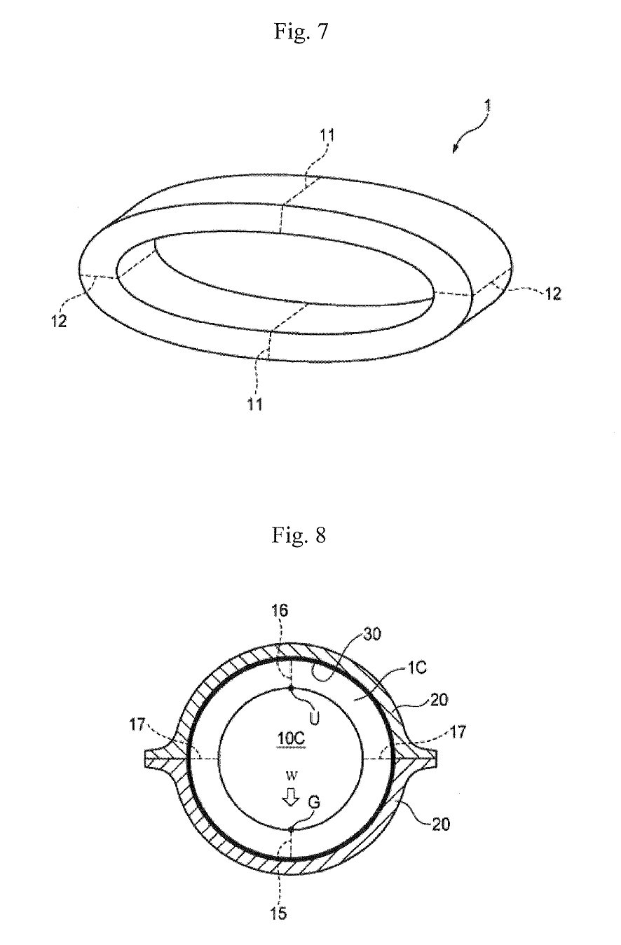

The form of the holding materials 1, 1A and 1B is not particularly limited and may have a single mat shape (mat-shaped holding material) or may have a cylindrical shape (cylindrical holding material) of which a cross-sectional shape of an elliptical or tack-shaped. A mat-type holding material 1 (1A) is shown in FIG. 6. A depressed part is formed at one end of the holding material, a projected part is formed at the other end thereof, and the depressed part and the projected part are joined so as to fit. A cylindrical holding material having the cross-section of an elliptical shape as shown in FIG. 1 is shown in FIG. 7. The mat-type holding material requires operation of winding the same around the catalyst carriers 10 or 10A. Therefore, considering fuses and costs, the cylindrical holding material is advantageous.

Each of the above embodiments is not limited to the constitution that both a higher basis weight part positioned downward in a vertical direction in a catalyst carrier and a higher basis weight part positioned upward in a vertical direction have the same basis weight, and the basis weight of the higher basis weight part positioned downward in a vertical direction may be set higher than that of the higher basis weight part positioned upward in a vertical direction, or conversely, the basis weight of the higher basis weight part positioned downward in a vertical direction may be set lower than that of the higher basis weight part positioned upward in a vertical direction.

### Sixth Embodiment

The catalyst carrier having flattened cross-section is described in each of the above embodiments. In the holding material for a columnar catalyst carrier having circular cross-section, the higher basis weight part and the lower basis weight part can similarly be provided.

As shown in the cross-sectional view of FIG. 8, in a holding material 1C, a higher basis weight part is formed in a part contacting a bottom G of a catalyst carrier of 10C and to which the largest load (which is shown by arrow W in FIG. 8) is applied, along its thickness direction (a part shown by the reference numeral 15). Another higher basis weight part is further formed in a part facing the higher basis weight part, that is, a part contacting a top U of the catalyst carrier 10C, along its thickness direction (a part shown by the reference numeral 16). Furthermore, a lower basis weight part is formed at a middle point of the both higher basis weight parts of the catalyst carrier 10C along its thickness direction (a part shown by the reference numeral 17). The basis weight is gradually decreased toward the lower basis weight part from the higher basis weight part. The higher basis weight part and the lower basis weight part are not limited to only a point along the thickness direction, but may be formed with a given width along the circumferential direction of the catalyst carrier 10C, respectively.

The present embodiment is also not limited to the constitution that both the higher basis weight part contacting the bottom G of the catalyst carrier 10C and the higher basis weight part contacting the top U have the same basis weight, and the basis weight of the part contacting the bottom G may be set higher than that of the part contacting the top U, or conversely, the basis weight of the part contacting the bottom G may be set lower than the basis weight of the part contacting the top U. One of those constitutions can be selected depending on the deterioration degree of the holding material due to vibration and the deterioration degree of the holding material due to load of the catalyst carrier 10C.

The constituent material of the holding material and the ratio between the higher basis weigh part and the lower basis weight part are the same as in other embodiments. The higher basis weigh part and the lower basis weight part may have a given width, and a low friction sheet 30 may be attached. Furthermore, the holding material can have a cylindrical shape other than a mat shape.

A method for manufacturing the above holding material is described below.

### (First Manufacturing Method)

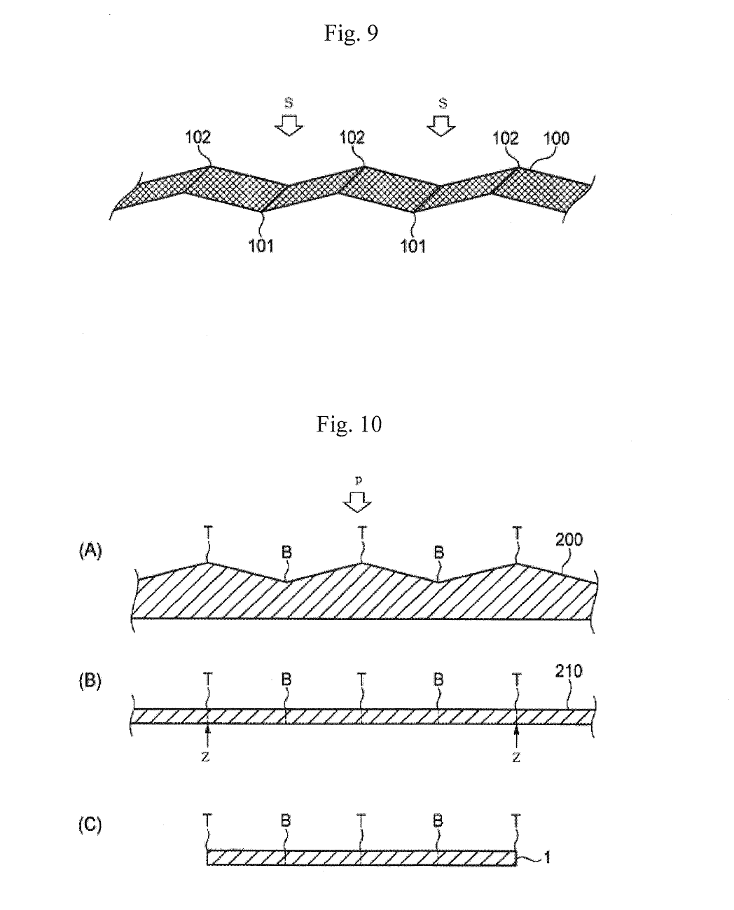

This manufacturing method is a method for manufacturing the holding material 1 shown in FIG. 1. A dewatering molding tool 100 which is folded such that a bottom 101 (deeper region) and a top 102 (shallower region) appear in an equal interval as shown in FIG. 9 is used, an aqueous slurry containing constituent materials of the holding material is poured thereto from the upper side of the figure (which is shown by arrow S in FIG. 9; the same shall apply hereinafter), and the constituent materials of the holding material are deposited to the entire surface of the dewatering molding tool 100 by dewatering molding. Thus, a region that a thickness is gradually decreased toward the top 102 from the bottom 101 is formed. The aperture ratio of the dewatering molding tool 100 is preferably uniform over the entire surface from the standpoint of the production, but the aperture ratio can partially be varied.

Incidentally, the dewatering molding tool 100 is equipped with a frame surrounding the whole thereof, but the frame is omitted in FIG. 9. The same shall apply to the manufacturing methods described below. The dewatering molding tool 100 is sufficient if it can transmit water in the aqueous slurry therethrough and can leave the constituent materials of the holding material, such as inorganic fibers, on the surface thereof (upper side of the figure). For example, use can be made of a metal mesh, a flat plate having many fine holes formed therein, and the like. Here, explanation will be made using a metal mesh as an example.

Subsequently, the dewatering molding tool 100 is removed. As a result, a wet molded article 200 having a cross-sectional shape that a top T corresponding to the bottom 101 of the dewatering molding tool 100 and a bottom B corresponding to the top 102 of the dewatering molding tool 100 alternatively appear continuously as shown in FIG. 10(A) can be obtained.

Then, the wet molded article 200 is pressed from the upper side of the figure (which is shown by arrow p in FIG. 10(A); the same shall apply hereinafter) to have a uniform thickness, and then dried at, for example, from 100 to 200° C., thereby obtaining a long sheet 210 in which the part corresponding to the top T has a higher basis weight and the basis weight is gradually decreased toward the part corresponding to the bottom B of both ends, as shown in FIG. 10(B).

Next, as shown in FIG. 10(B), the sheet 210 is cut along the top T at both ends (cut at the portion shown by arrow Z in FIG. 10(B); the same shall apply hereinafter) taking “top T/bottom B/top T/bottom B/top T” as one unit, thereby obtaining the holding material 1 shown in FIG. 10(C). This holding material 1 has a flat mat shape, and both ends thereof are processed into a concavo-convex shape as shown in FIG. 6.

In this manufacturing method, the dewatering molding tool 100 may have a wave shape in the side view, in addition to a shape having the bottom 101 and the top 102 alternatively bent as in FIG. 9.

### (Second Manufacturing Method)

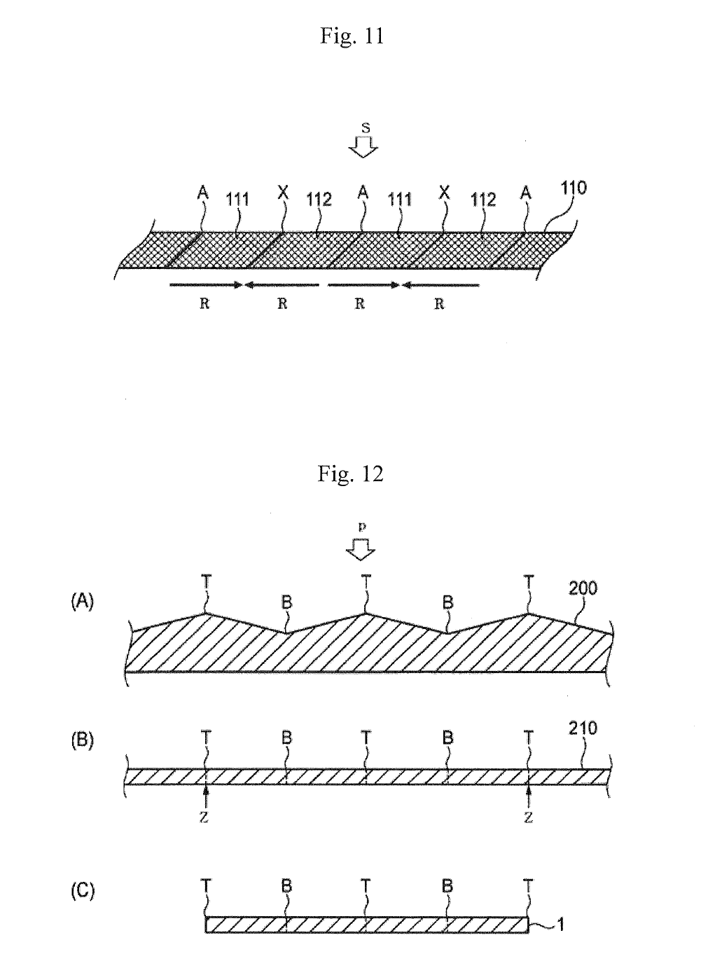

This manufacturing method is also a method for manufacturing the holding material 1 shown in FIG. 1, but a flat dewatering molding tool 110 in which a first region 111 having an aperture ratio gradually decreased and a second region 112 having an aperture ratio gradually increased are alternatively connected as shown in FIG. 11 is used. Here, arrow represented by R in FIG. 11 indicates the direction along which the aperture ratio is gradually decreased. The same shall apply hereinafter. In the first region 111 of the dewatering molding tool 110, the aperture ratio is gradually decreased from a starting point (point A) as the maximum, and in the second region 112 connecting to the first region 111, the aperture ratio is minimum at the connecting part (point X) with the first region 111 and gradually increased therefrom. The dewatering molding tool 110 repeats such an increase and decrease pattern of the aperture ratio. An aqueous slurry containing constituent materials of the holding material is poured into the dewatering molding tool 110, and the constituent materials of the holding material are deposited to the entire surface of the dewatering molding tool 110 by dewatering molding. The dewatering molding tool 110 is preferably flat (depth is uniform over the entire surface) from the standpoint of the production, but the depth can partially be varied.

Subsequently, the dewatering molding tool 110 is removed. As a result, a wet molded article 200 having a cross-sectional shape that a top T and a bottom B alternately appear continuously as shown in FIG. 12(A) can be obtained. A large amount of water is suctioned with increasing the aperture ratio, thereby inorganic fibers are sucked. As a result, the amount of fibers deposited is largest at the point A, and the amount of fibers deposited is smallest at the point X. Therefore, the wet molded article 200 has a cross-sectional shape as shown in FIG. 12(A).

Then, similar to the first manufacturing method, the wet molded article 200 is pressed from the upper side of the figure to have a uniform thickness, and then dried, thereby obtaining a long sheet 210 in which the part corresponding to the top T has a higher basis weight and the basis weight is gradually decreased toward the part corresponding to the bottom B of both ends, as shown in FIG. 12(B).

Next, as shown in FIG. 12(B), the sheet 210 is cut along the top T at both ends taking “top T/bottom B/top T/bottom B/top T” as one unit, thereby obtaining the holding material 1 shown in FIG. 12(C). This holding material 1 has a flat mat shape, and both ends thereof are processed into a concavo-convex shape as shown in FIG. 6.

### (Third Manufacturing Method)

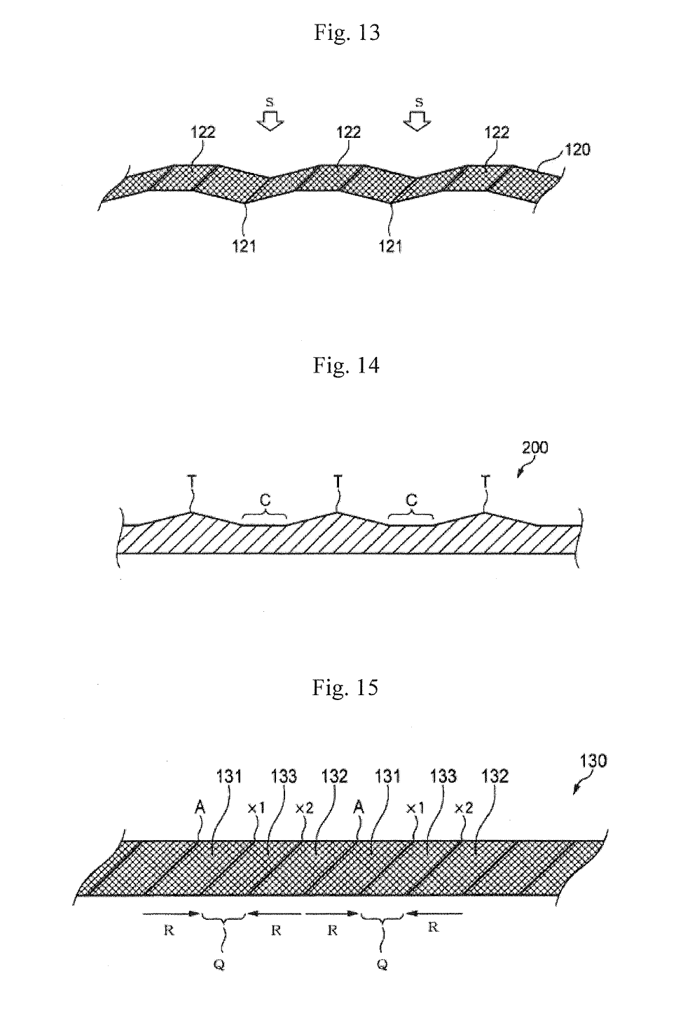

This manufacturing method is a method for manufacturing the holding material 1 shown in FIG. 2. A dewatering molding tool 120 used is shown in FIG. 13, and has a structure that the top 102 of the dewatering molding tool 100 shown in FIG. 9 is changed to a flat part 122 with a given width. An aqueous slurry containing constituent materials of the holding material is poured thereto from the upper side of the figure, and the constituent materials of the holding material are deposited to the entire surface of the dewatering molding tool 120 by dewatering molding.

Subsequently, the dewatering molding tool 120 is removed. As a result, a wet molded article 200 having a cross-sectional shape that a top T corresponding to a bottom 121 of the dewatering molding tool 120 and a flat part C corresponding to a flat part 122 of the dewatering molding tool 120 are connected through a gradient surface as shown in FIG. 14 can be obtained.

Then, similar to the first manufacturing method, the wet molded article 200 is pressed from the upper side of the figure to have a uniform thickness, dried, and then cut, thereby obtaining a mat-shaped holding material. Both ends thereof obtained are processed into a concavo-convex shape as shown in FIG. 6.

### (Fourth Manufacturing Method)

This manufacturing method is a method for manufacturing the holding material shown in FIG. 2, but a flat dewatering molding tool 130 having a third region 133 (which is shown by the reference numeral Q in FIG. 15) having a constant aperture ratio formed between a first region 131 having an aperture ratio gradually decreased and a second region 132 having an aperture ratio gradually increased as shown in FIG. 15 is used. In the first region 131 of the dewatering molding tool 130, the aperture ratio is gradually decreased from a starting point (point A) as the maximum, and reaches the minimum at a connecting part (point X1) with the third region 133. Then, the aperture ratio is gradually increased from a connecting part (point X2) between the third region 133 and the second region 132 as a starting point, and reaches the maximum at a connecting part (point A) with another first region 131.

An aqueous slurry containing constituent materials of the holding material is poured thereto from the upper side of the figure, and the constituent materials of the holding material are deposited to the entire surface of the dewatering molding tool 130 by dewatering molding. Then, the dewatering molding tool 130 is removed, thereby obtaining the wet molded article 200 shown in FIG. 14.

Then, similar to the first manufacturing method, the wet molded article 200 is pressed from the upper side of the figure to have a uniform thickness, dried, and then cut, thereby obtaining a mat-shaped holding material. Both ends of the holding material obtained are processed into a concavo-convex shape as show in FIG. 6.

### (Fifth Manufacturing Method)

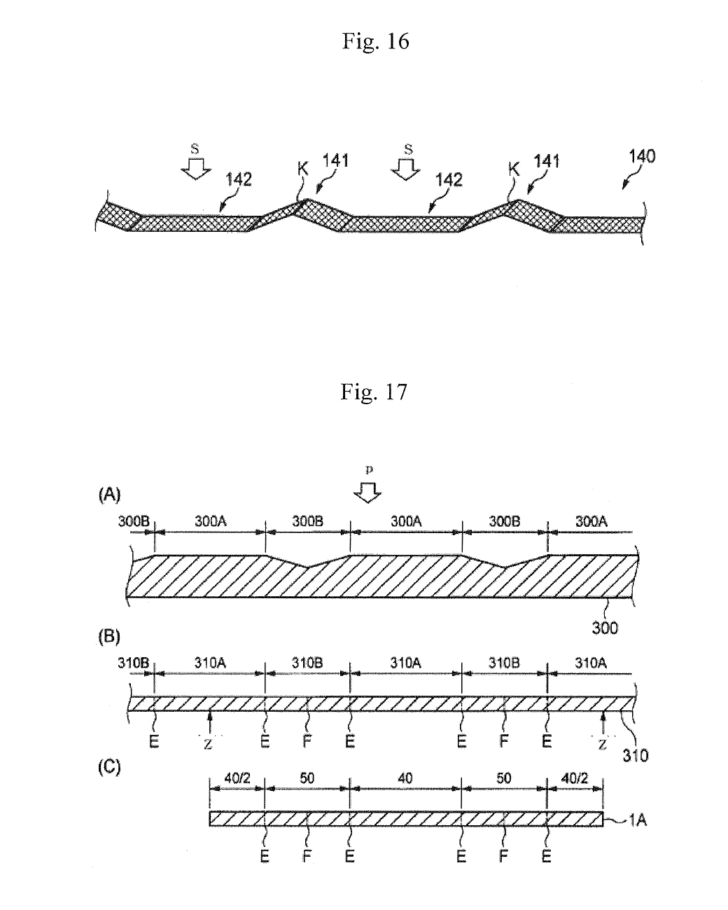

This manufacturing method is a method for manufacturing the holding material 1A shown in FIG. 3. A dewatering molding tool 140 in which the aperture ratio is uniform over the entire surface and a planar part 142 corresponding to the flat part 40 of the holding material 1A is continuously formed on both gradient surfaces of a chevron part 141 corresponding to the curved part 50 of the holding material 1A as shown in FIG. 16, is used. The total length of two gradient surfaces of the chevron part 141 of the dewatering molding tool corresponds to the width of the curved part 50 of the holding material 1A, and a top K of the chevron part 141 of the dewatering molding tool corresponds to a part (F) having a lower basis weight of the holding material 1A. The width of the planar part 142 of the dewatering molding tool corresponds to the width of the flat part 40 of the holding material 1A. An aqueous slurry containing constituent materials of the holding material is poured thereto from the upper side of the figure, and the constituent materials of the holding material are deposited to the entire surface of the dewatering molding tool 140 by dewatering molding.

Subsequently, the dewatering molding tool 140 is removed. As a result, a wet molded article 300 having a cross-sectional shape that a part 300A corresponding to the planar part 142 of the dewatering molding tool has a large thickness and a part 300B having a thickness gradually decreased toward the center (corresponding to the top K) in response to the gradient surface of the chevron part 141 of the dewatering molding tool is formed at both ends thereof as shown in FIG. 17(A), can be obtained.

Then, similar to the first manufacturing method, the wet molded article 300 is pressed from the upper side of the figure to have a uniform thickness, and then dried, thereby obtaining a sheet 310 having basis weight varied depending on the thickness. Specifically, as shown in FIG. 17(B), a part 310A corresponding to the part 300A of the wet molded article 300 has a higher basis weight, and the basis weight in a part 310B corresponding to the part 300B is gradually decreased toward the center. The reference numerals E and F in the figure correspond to respective positions of the holding material 1A shown in FIG. 3.

Next, as shown in FIG. 17(C), a part 310A positioned outside the two parts 310B interposing another part 310A therebetween is cut at a position of the half of the width thereof to obtain the holding material 1A. The holding material 1A is obtained by developing the holding material 1A shown in FIG. 3 into a plain face taking a center line of the flat part 40 as a starting point, and has a flat mat shape. Therefore, both ends have a half width of the flat part 40. The both ends are processed into a concavo-convex shape as shown in FIG. 6.

### (Sixth Manufacturing Method)

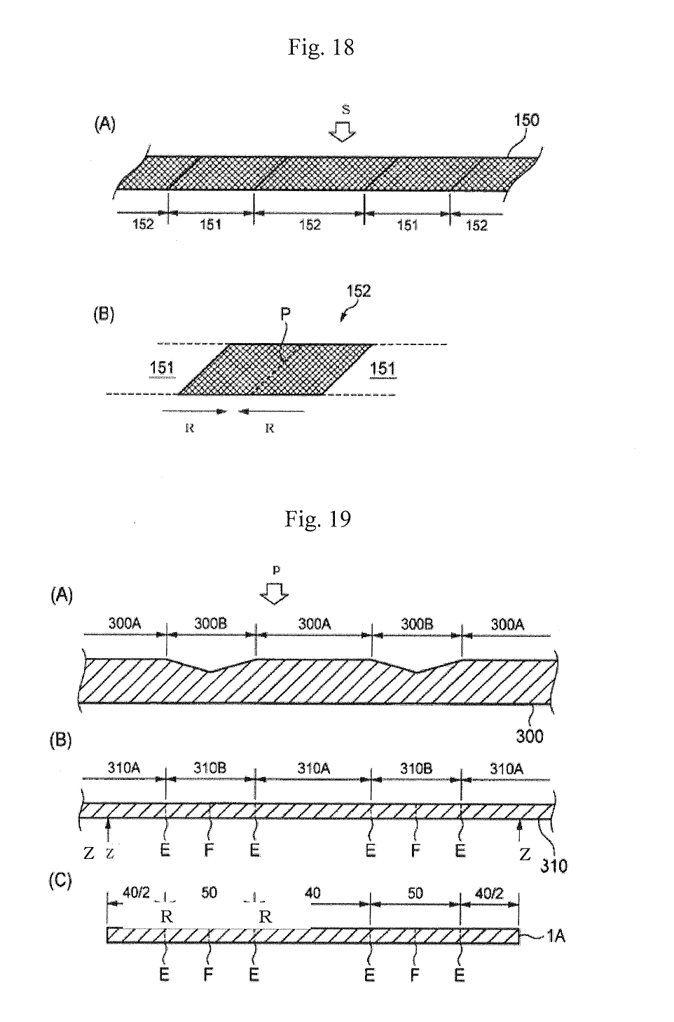

This manufacturing method is also a method for manufacturing the holding material 1A shown in FIG. 3, but a dewatering molding tool 150 in which a first region 151 corresponding to the flat part 40 of the holding material 1A and a second region 152 corresponding to the curved part 50 of the holding material 1A are alternately formed as shown in FIG. 18 is used. In the first region 151, the aperture ratio is uniform over the entire surface. In the second region 152, the aperture ratio is gradually decreased toward a center line P as shown in FIG. 18(B). An aqueous slurry containing constituent materials of the holding material is poured into the dewatering molding tool 150 from the upper side thereof, and the constituent materials of the holding material are deposited to the entire surface of the dewatering molding tool 150 by dewatering molding.

Subsequently, the dewatering molding tool 150 is removed. As a result, a wet molded article 300 in which a part 300A corresponding to the flat part 40 of the holding material 1A is formed and a part 300B corresponding to the curved part 50 of the holding material 1A is formed at both ends of the part 300A, can be obtained.

Then, similar to the first manufacturing method, the wet molded article 300 is pressed from the upper side of the figure to have a uniform thickness, and then dried, thereby obtaining a sheet 310 having a basis weight varied depending on the thickness. Specifically, as shown in FIG. 19(B), a part 310A corresponding to the part 300A of the wet molded article 300 has a higher basis weight, and the basis weight in the part 310B corresponding to the part 300B of the wet molded article 300 is gradually decreased toward the center (corresponding the center line P). The reference numerals E and F in the figure correspond to respective positions of the holding material 1A shown in FIG. 3.

Next, as shown in FIG. 19(C), a part 310A positioned outside the two parts 310B interposing another part 310A therebetween is cut at a position of the half of the width thereof to obtain the holding material 1A. The holding material 1A is obtained by developing the holding material 1A shown in FIG. 3 into a plain face taking a center line of the flat part 40 as a starting point, and has a flat mat shape. Therefore, both ends have a half width of the flat part 40. The both ends are processed into a concavo-convex shape as shown in FIG. 6.

### (Seventh Manufacturing Method)

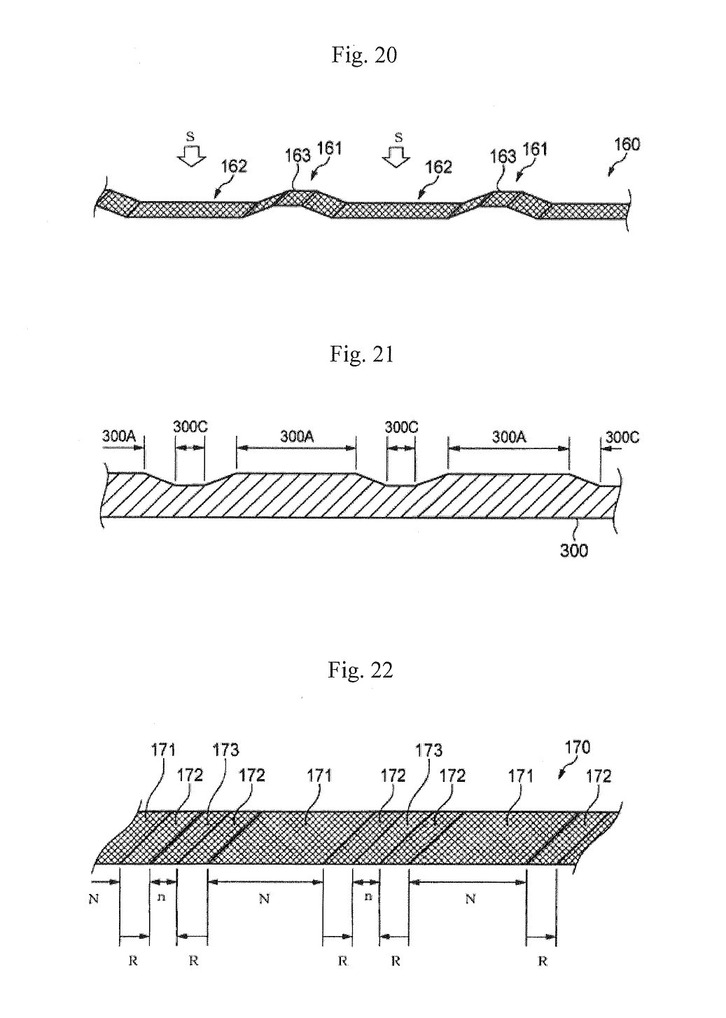

This manufacturing method is a method for manufacturing the holding material 1A shown in FIG. 4. A dewatering molding tool 160 used is shown in FIG. 20, and has a structure that the top K of the dewatering molding tool 140 shown in FIG. 16 is changed to a flat part 163 having a given width. Specifically, the dewatering molding tool 160 in which a projected part 161 having a flat part 163 is formed on a part corresponding to the top K of the dewatering molding tool 140 shown in FIG. 16 and a planar part 162 is formed at the both ends thereof is used. An aqueous slurry containing constituent materials of the holding material is poured thereto from the upper side of the figure, and the constituent materials of the holding material are deposited to the entire surface of the dewatering molding tool 160.

Subsequently, the dewatering molding tool 160 is removed. As a result, a wet molded article 300 having a cross-sectional shape that a part 300A corresponding to the planar part 162 of the dewatering molding tool 160 has a large thickness and, continuously to gradient surfaces of which both ends are decreased, a flat part 300C having a smaller thickness is formed as shown in FIG. 21, can be obtained.

Then, similar to the first manufacturing method, the wet molded article 300 is pressed from the upper side of the figure to have a uniform thickness, dried, and then cut, thereby obtaining a mat-shaped holding material. Both ends the holding material obtained are processed into a concavo-convex shape as show in FIG. 6.

### (Eighth Manufacturing Method)

The wet molded article 300 shown in FIG. 21 can be obtained by this manufacturing method. A dewatering molding tool 170 used is shown in FIG. 22. In FIG. 22, the reference numeral N and reference numeral n indicate a region having a largest aperture ratio and a region having a smallest aperture ratio, respectively, and arrow R indicates the direction along which the aperture ration is gradually decreased. In the dewatering molding tool 170, a second region 172 having the aperture ratio gradually decreased is provided at both ends of a first region 171 having a larger aperture ratio corresponding to the part 300A of the wet molded article shown in FIG. 21, and a third region 173 having a smaller aperture ratio is formed between the two second regions 172 and 172 corresponding to the part 300C of the wet molded article shown in FIG. 21. An aqueous slurry containing constituent materials of the holding material is poured from the upper side of the figure, and the constituent materials of the holding material are deposited to the entire surface of the dewatering molding tool 170 by dewatering molding. The dewatering molding tool 170 is removed, thereby obtaining a wet molded article 300 shown in FIG. 21. Next, it is subjected to pressing, drying and cutting, thereby obtaining a mat-shaped holding material.

### (Ninth Manufacturing Method)

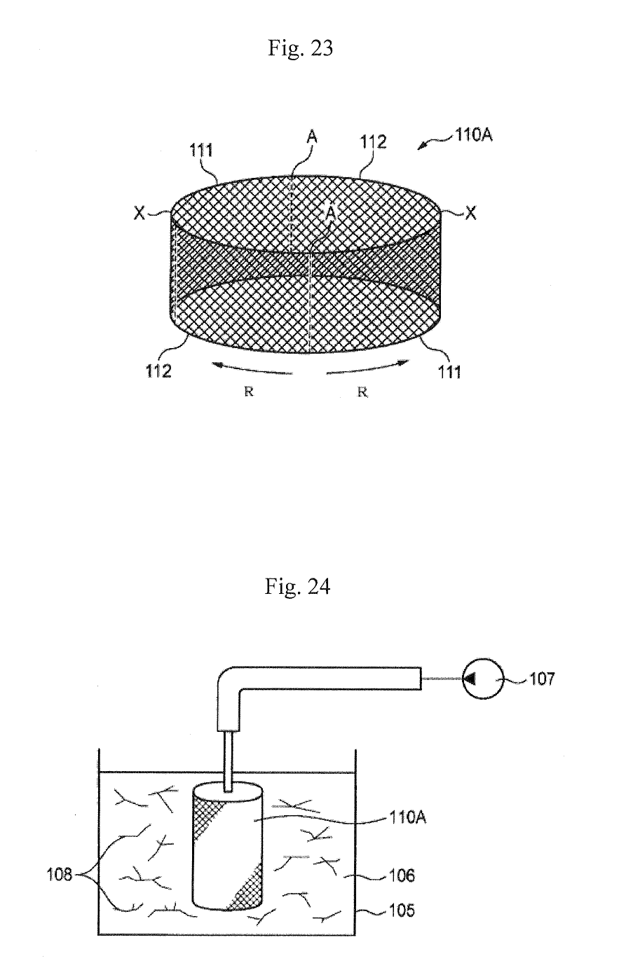

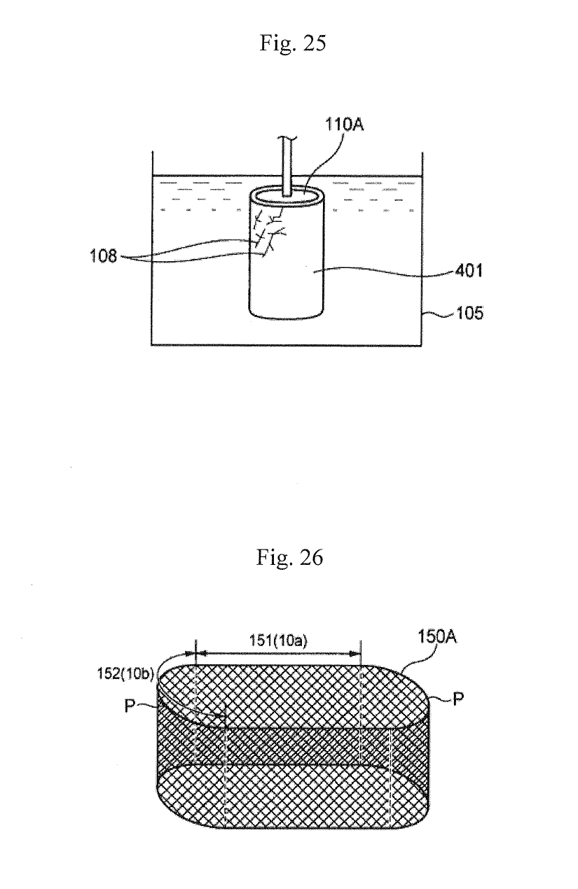

This manufacturing method is a method for manufacturing the cylindrical holding material 1 shown in FIG. 7. A dewatering molding tool 110A used is shown in FIG. 23, and has a structure that the portion “first region 111/second region 112/first region 111/second region 112” of the flat plate-shaped dewatering molding tool 110 shown in FIG. 11 is cut out, and points A at both ends thereof are connected with each other to form into an elliptical shape. Specifically, the dewatering molding tool 110A is that the two points A at which the outer periphery and the minor axis of the ellipse intersect to each other has the maximum aperture ratio, the aperture ratio is gradually decreased along the major axis direction from the points A, and two points X at which the outer periphery and the major axis of the ellipse intersect to each other has the minimum aperture ratio. As shown in FIG. 24, the cylindrical dewatering molding tool 110A is dipped in an aqueous slurry 106 stored in a slurry reservoir 105, and the aqueous slurry is suctioned from the inside of the cylindrical dewatering molding tool 110A by a suction pump 107. Thus, as shown in FIG. 25, inorganic fibers 108 are deposited to the surface of the cylindrical dewatering molding tool 110A, thereby obtaining a cylindrical wet molded article 401. After demolding, the wet molded article is compressed into a uniform thickness while maintaining the cylindrical shape, and then dried, thereby obtaining a cylindrical holding material having a cross-section of an elliptical shape.

### (Tenth Manufacturing Method)

This manufacturing method is a method for manufacturing a cylindrical holding material having a cross-section of a track shape (regarding the cross-sectional shape, refer to FIG. 3). A dewatering molding tool 150A used is shown in FIG. 26, and has a structure that the portion “first region 151/second region 152/first region 151/second region 152” of the flat plate-shaped dewatering molding tool 150 shown in FIG. 18 is cut out, both ends thereof are connected with each other, and two second regions 152 are formed into an arc shape. Similar to the ninth manufacturing method, the cylindrical dewatering molding tool obtained is dipped in an aqueous slurry stored in a slurry reservoir, and the aqueous slurry is suctioned from the inside of the cylindrical dewatering molding tool, thereby obtaining a cylindrical wet molded article. After demolding, the wet molded article is compressed to have a uniform thickness while maintaining the cylindrical shape, and then dried, thereby obtaining a cylindrical holding material having a cross-section of a track shape.

### (Eleventh Manufacturing Method)

This manufacturing method is a method for manufacturing the holding material 1C shown in FIG. 8. However, in the case that the higher basis weight part of the holding material 1C contacting the bottom G of a catalyst carrier 10C and that contacting the top U thereof have the same basis weight, the dewatering molding tool 100 shown in FIG. 9, or the dewatering molding tool 11 shown in FIG. 11 may be used, and the similar operations may be conducted.

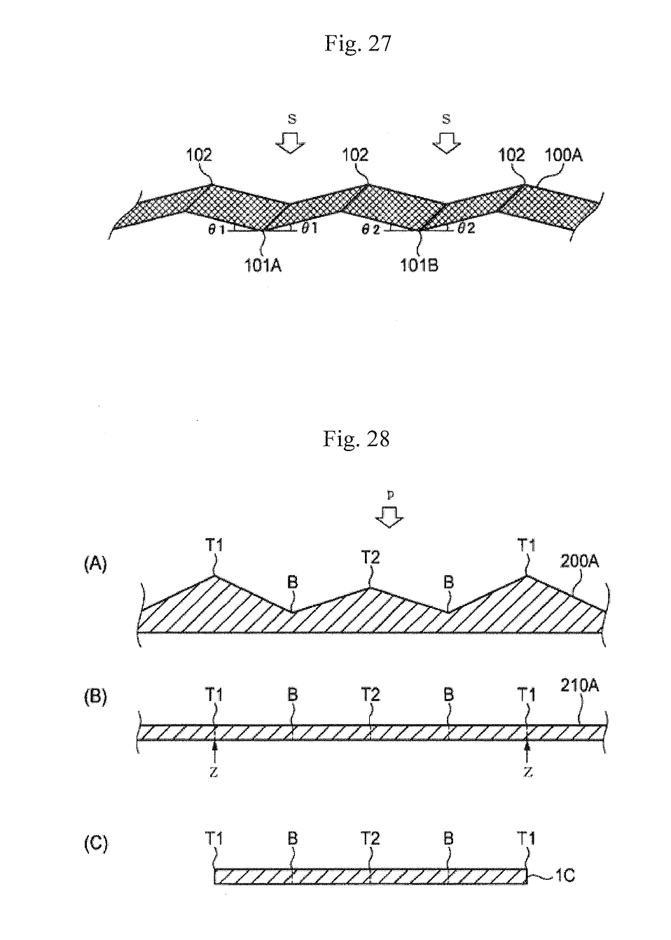

In the case that the higher basis weight part of the holding material 1C contacting the bottom G of the catalyst carrier 10C and the higher basis weight part contacting the top U thereof have different basis weight from each other, a dewatering molding tool 100A having the same interval between a bottom 101 and a top 102, and having a gradient angle (θ1) reaching one bottom 101 from the top 102 and a gradient angle (θ2) reaching the other bottom 101 from the top 102 that are different from each other as shown in FIG. 27, is used, and the similar operations are conducted. For example, in the case that the higher basis weight part of the holding material 1C contacting the bottom G of the catalyst carrier 10C has a basis weight higher than that of the higher basis weight part contacting the top U, a dewatering molding tool in which θ1 is larger than O₂, and one bottom 101A is deeper than other bottom 101B is used. An aqueous slurry containing constituent materials of the holding material is poured thereto, thereby obtaining a wet molded article 200A having a cross-sectional shape that a top T1 corresponding to the bottom 101A of the dewatering molding tool is higher than a top T2 corresponding to the bottom 101B of the dewatering molding tool as shown in FIG. 28(A). The wet molded article 200A is pressed from the upper side to have a uniform thickness, and then dried, thereby obtaining a long sheet 210A in which a part corresponding to the top T1 of the wet molded article 200A has a basis weight higher than that of a part corresponding to the top T2 of the wet molded article 200A, and the basis weight is gradually decreased toward the part corresponding to the bottom B of the wet molded article 200A, as shown in FIG. 28(B). As shown in FIG. 28(C), taking “top T1/bottom B/top T2/bottom B/top T1” as one unit, the sheet is cut along the tops T1 of the both ends thereof, thereby obtaining a holding material 1C.

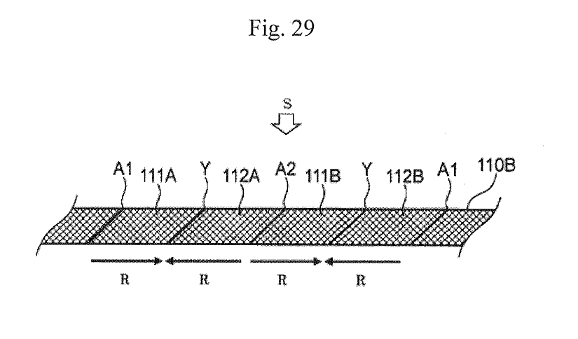

Alternatively, a dewatering molding tool 110B shown in FIG. 29 can be used. The dewatering molding tool 110B shown is that the aperture ratio at a starting point A1 is larger than the aperture ratio at a starting point A2; a middle point Y between those starting points has the minimum aperture ratio; and a region 111A in which the aperture ratio is gradually decreased toward the middle point Y from the starting point A1, a region 112A in which the aperture ratio is gradually increased toward the starting point A2 from the middle point Y, a region 111B in which the aperture ratio is gradually decreased toward another middle point Y from the starting point A2, and a region 112B in which the aperture ratio is gradually increased toward the starting point A1 from the middle point Y are connected. The degree of change of the aperture ratio in the region 111A and the region 112B may be larger than that in the region 112A and the region 111B. An aqueous slurry containing constituent materials of the holding material is poured into such dewatering molding tool 110B, thereby obtaining a wet molded article 200A having a cross-sectional shape that the top T1 corresponding the A1 of the dewatering molding tool 110B is higher than the top T2 corresponding the A2 of the dewatering molding tool 110B as shown in FIG. 28. It is similarly subjected pressing, drying and cutting, thereby obtaining a holding material 1C.

### (Twelfth Manufacturing Method)

In the case that the holding material 1C is a cylindrical holding material, a flat plate-shaped dewatering molding tool shown in FIG. 11 or FIG. 29 is processed into a cylindrical shape, and the cylindrical dewatering molding tool obtained is dipped in a slurry reservoir as shown in FIG. 24, followed by suction with a pump, compressing and drying. Specifically, in the case of the flat plate-shaped dewatering molding tool shown in FIG. 11, the portion “first region 111/second region 112/first region 111/second region 112” is cut out and the both end thereof are connected with each other. In the case of the flat plate-shaped dewatering molding tool shown in FIG. 29, the portion “first region 111A/second region 112A/first region 111B/second region 112B” is cut out and the both end thereof are connected with each other.

### EXAMPLES

The present invention is described in further detail below by reference to the following Examples and Comparative Examples, but it should be understood that the invention is not construed as being limited thereto. In Examples 1 and 2 and Comparative Example 1, holding materials for an elliptical catalyst carrier having a minor axis of 80 mm and a major axis of 120 mm were prepared, and in Example 3 and Comparative Example 2, holding materials for a columnar catalyst carrier having a diameter of 100 mm were prepared.

### Example 1

An aqueous slurry consisting of 100 parts by mass of alumina fibers (alumina: 96 mass %, silica: 4 mass %), 0.5 parts by mass of an acrylic resin as an organic binder, 3 parts by mass of colloidal silica as an inorganic binder, and 10,000 parts by mass of water was prepared. The aqueous slurry was poured into a dewatering molding tool having a uniform aperture ratio over the entire surface, and folded such that a top and a bottom appear at an equal interval as shown in FIG. 9, followed by dewatering molding to obtain a wet molded article. The maximum difference between the top and the bottom was 10 mm. The whole wet molded article was dried at 100° C. while compressing in a thickness direction so as to have a uniform thickness, thereby obtaining a sheet having a width of 40 mm in which a part corresponding to the bottom of the dewatering molding tool has a higher basis weight and the basis weight is gradually decreased toward both ends thereof as shown in FIG. 10(B). As shown in FIG. 10(C), the sheet was cut along the outer tops of the molded article of two bottoms interposing the top therebetween, thereby obtaining a mat-shaped holding material. The holding material obtained had a nearly uniform thickness of 61 mm in average, and the variation of the thickness was ±0.5 mm or less. The part corresponding to the top of the molded article had a basis weight of 1,100 g/m², and the part corresponding to the bottom had a basis weight of 1,000 g/m². Thus, the ratio of basis weight between those was 1.1 times. The holding material contained 96.6 mass % of the inorganic fibers, 0.5 mass % of the organic binder and 2.9 mass % of the inorganic binder, based on the total amount thereof. As a result of measurement of ignition loss, an organic component was 0.5 mass %.

The holding material obtained was wound around a catalyst carrier such that a site corresponding to the top of the molded article coincides with an intersection point between an outer periphery of cross-section (ellipse) of the catalyst carrier and a minor axis of the ellipse as shown in FIG. 1, thereby obtaining a catalyst carrier unit. The catalyst carrier unit obtained was inserted with pressure in an elliptical cylindrical stainless (SUS) casing having an outer minor axis of 91 mm, an outer major axis of 131 mm and a thickness of 1.5 mm (gap: 4.0 mm), thereby preparing a catalyst converter. After the insertion with pressure, the outer major axis remained unchanged, but the outer minor axis expanded 0.8 mm. From this fact, a gap at a major axis part was 4.4 mm. As a result, the holding material had a density of 0.25 g/cm³ in all of sites thereof.

### Example 2

An aqueous slurry consisting of 100 parts by mass of alumina fibers (alumina: 80 mass %, silica: 20 mass %) as inorganic fibers, 0.5 parts by mass of an acrylic resin as an organic binder, 3 parts by mass of colloidal silica as an inorganic binder, and 10,000 parts by mass of water was prepared. The aqueous slurry was poured into a flat dewatering molding tool in which the aperture ratio is continuously changed from 50% to 75% as shown in FIG. 11, followed by dewatering molding, to obtain a wet molded article. The whole wet molded article was dried at 100° C. while compressing in a thickness direction so as to have a uniform thickness, thereby obtaining a sheet having a width of 40 mm in which a part corresponding to the starting point (point A in FIG. 11) having a largest aperture ratio of the dewatering molding tool has a higher basis weight and the basis weight is gradually decreased toward both ends thereof as shown in FIG. 12(B). As shown in FIG. 12(C), the sheet was cut along the outer tops of the molded article of two bottoms interposing the top therebetween, thereby obtaining a mat-shaped holding material. The holding material obtained had a nearly uniform thickness of 6.7 mm in average, and the variation of the thickness was ±0.5 mm or less. The part corresponding to the top of the molded article had a basis weight of 1,100 g/m², and the part corresponding to the bottom had a basis weight 1,000 g/m². Thus, the ratio of basis weight between those was 1.1 times. The holding material contained 96.6 mass % of the inorganic fibers, 0.5 mass % of the organic binder and 2.9 mass % of the inorganic binder, based on the total amount thereof. As a result of measurement of ignition loss, an organic component was 0.5 mass %.

The holding material obtained was wound around a catalyst carrier such that a site corresponding to the top of the molded article coincides with an intersection point between an outer periphery of cross-section (ellipse) of the catalyst carrier and a minor axis of the ellipse as shown in FIG. 1, thereby obtaining a catalyst carrier unit. The catalyst carrier unit obtained was inserted with pressure in an elliptical cylindrical SUS casing having an outer minor axis of 91 mm, an outer major axis of 131 mm and a thickness of 1.5 mm (gap: 4.0 mm), thereby preparing a catalyst converter. After the insertion with pressure, the outer major axis remained unchanged, but the outer minor axis expanded 0.8 mm. From this fact, a gap at a major axis part was 4.4 mm. As a result, the holding material had a density of 0.25 g/cm³ in all of sites thereof.

### Comparative Example 1

The same aqueous slurry as used in Example 1 was poured into a flat dewatering molding tool having a uniform aperture ratio over the entire surface, followed by dewatering molding, compression and drying, thereby obtaining a holding material having a thickness of 6.7 mm and a basis weight of 1,000 g/m².

The holding material obtained was wound around a catalyst carrier, thereby obtaining a catalyst carrier unit. The catalyst carrier unit obtained was inserted with pressure in an elliptical cylindrical SUS casing having an outer minor axis of 91 mm, an outer major axis of 131 mm and a thickness of 1.5 mm (gap: 4.0 mm), thereby preparing a catalyst converter. After the insertion with pressure, the outer major axis remained unchanged, but the outer minor axis expanded 0.8 mm. From this fact, a gap at a major axis part was 4.4 mm. As a result, the holding material had density of 0.25 g/cm³ at a major axis part and a density of 0.227 g/cm³ at a minor axis part.

### (Evaluation of Holding Force)

Regarding the catalyst converters obtained in Examples 1 and 2 and Comparative Example 1, holding force of the holding material was evaluated using a heating vibrator. The evaluation conditions are as follows. The results obtained are shown in Table 1.

Test temperature: 900° C.

Acceleration: 60G

TABLE 1
Results of heating vibration test

| | Example 1 | Example 2 | Comparative Example 1 |
|---|---|---|---|
| Result | Good | Good | Poor |
| Remarks | | | Dropout of carrier |

It can be seen from the above results that the holding materials of Examples 1 and 2 according to the present invention can hold the carrier with a uniform force from the whole circumferential directions.

### Example 3

An aqueous slurry consisting of 100 parts by mass of alumina fibers (alumina: 96 mass %, silica: 4 mass %), 0.5 parts by mass of an acrylic resin as an organic binder, 3 parts by mass of colloidal silica as an inorganic binder, and 10,000 parts by mass of water was prepared. The aqueous slurry was poured into a dewatering molding tool having a uniform aperture ratio over the entire surface, and folded such that a top and a bottom appear at an equal interval as shown in FIG. 9, followed by dewatering molding, to obtain a wet molded article. The maximum difference between the top and the bottom was 10 mm. The whole wet molded article was dried at 100° C. while compressing in a thickness direction so as to have a uniform thickness, thereby obtaining a sheet having a width of 40 mm in which a part corresponding to the bottom of the dewatering molding tool has a higher basis weight, and the basis weight is gradually decreased toward both ends thereof as shown in FIG. 10(B). As shown in FIG. 10(C), the sheet was cut along the outer tops of the molded article of two bottoms interposing the top therebetween, thereby obtaining a mat-shaped holding material. The holding material obtained had a nearly uniform thickness of 6.7 mm in average, and the variation of the thickness was ±0.5 mm or less. The part corresponding to the top of the molded article had a basis weight of 960 g/m², and the part corresponding to the bottom had a basis weight of 840 g/m². The holding material contained 96.6 mass % of the inorganic fibers, 0.5 mass % of the organic binder and 2.9 mass % of the inorganic binder, based on the total amount thereof. As a result of measurement of ignition loss, an organic component was 0.5 mass %.

The holding material obtained was wound around a catalyst carrier such that the part having a higher basis weight coincides with the top and the bottom of the catalyst carrier as shown in FIG. 8, thereby obtaining a catalyst carrier unit. The catalyst carrier unit obtained was inserted with pressure in a cylindrical SUS casing having a diameter of 108 mm and a gap of 4.0 mm, thereby preparing a catalyst converter. As a result, the holding material had a density of 0.24 g/cm³ at the top, a density of 0.21 g/cm³ at the bottom, and had an average density of the whole circumference of 0.225 g/cm³.

### Comparative Example 2

The same aqueous slurry as used in Example 3 was poured into a flat dewatering molding tool having a uniform aperture ratio over the entire surface, followed by dewatering molding, compression and drying, thereby obtaining a holding material having a thickness of 6.7 mm and a basis weight of 900 g/m².

The holding material obtained was wound around a catalyst carrier, thereby obtaining a catalyst carrier unit. The catalyst carrier unit obtained was inserted with pressure in a cylindrical SUS casing having a diameter of 108 mm and a gap of 4.0 mm, thereby preparing a catalyst converter. As a result, the holding material had a density of 0.225 g/cm³ in all of sites thereof

### (Vibration Test)

Each of the catalyst converters obtained in Example 3 and Comparative Example 2 was attached to a heating vibrator, and was vibrated in a vertical direction to the openings of the catalyst carrier for 200 hours. Decreasing rate of carrier holding force before and after the test was measured using a load cell. The evaluation conditions are as follows, and the results obtained are shown in Table 2. Regarding Example 3, the converter was attached to the heating vibrator such that the top faces up and the bottom faces down.

Test temperature: 900° C.

Acceleration: 60G

TABLE 2
Result of holding force test

| | Example 3 | Comparative Example 2 |
|---|---|---|
| Decreasing rate | 10% | 30% |

While the present invention has been described in detail and with reference to specific embodiments thereof, it will be apparent to one skilled in the art that various changes and modifications can be made therein without departing from the spirit and scope of the present invention.

This application is based on Japanese Patent Application No. 2010-026498 filed on Feb. 9, 2010, the contents of which are incorporated herein by way of reference.

### REFERENCE SIGNS LIST

1, 1A, 1B, 1C: Holding material
10, 10A, 10B, 10C: Catalyst carrier
20: Casing
30: Low friction sheet
40: Flat part
50: Curved part
100, 100A, 110, 110B, 120, 130, 140, 150, 160, 170: Flat plate-shaped dewatering molding tool
110A, 150A: Cylindrical dewatering molding tool
200, 300: Wet molded article
210, 310: Sheet

1. (canceled)

2. A method for manufacturing a holding material for a catalyst converter, comprising: pouring an aqueous slurry containing inorganic fibers into a dewatering molding tool sectioned into a deeper region, a shallower region, and a region having a depth gradually decreased toward the shallower region from the deeper region; dewatering molding the aqueous slurry to obtain a wet molded article; and drying the wet molded article while compressing the whole wet molded article in a thickness direction.

3. A method for manufacturing a holding material for a catalyst converter, comprising: pouring an aqueous slurry containing inorganic fibers into a dewatering molding tool sectioned into a region having a largest aperture ratio, a region having a smallest aperture ratio, and a region having an aperture ratio gradually decreased toward the region having a smallest aperture ratio from the region having a largest aperture ratio; dewatering molding the aqueous slurry to obtain a wet molded article; and drying the wet molded article while compressing the whole wet molded article in a thickness direction.

4. (canceled)

5. A method for manufacturing a holding material for a catalyst converter, comprising: pouring an aqueous slurry containing inorganic fibers into a dewatering molding tool having a region in which a depth is gradually increased up to a first depth at one side and a region in which a depth is gradually increased up to a second depth at the other side, on the basis of a region having a shallower depth as a starting point; dewatering molding the aqueous slurry to obtain a wet molded article; and drying the wet molded article while compressing the whole wet molded article in a thickness direction.

6. A method for manufacturing a holding material for a catalyst converter, comprising: pouring an aqueous slurry containing inorganic fibers into a dewatering molding tool having a region in which an aperture ratio is gradually increased up to a first aperture ratio at one side and a region in which an aperture ratio is gradually increased up to a second aperture ratio at the other side, on the basis of a region having a smallest aperture ratio as a starting point; dewatering molding the aqueous slurry to obtain a wet molded article; and drying the wet molded article while compressing the whole wet molded article in a thickness direction.
